(19) United States
(12) Patent Application Publication
(10) Pub. No.: US 2024/0364136 A1
(43) Pub. Date: Oct. 31, 2024

(54) METHOD AND DEVICE FOR DETERMINING DAILY PEAK LOAD REGULATION CAPACITY OF HYDROPOWER STATION

(71) Applicants: Wuhan University, Wuhan City (CN); Guangxi Power Grid Corporation, Nanning City (CN)

(72) Inventors: Xueshan AI, Wuhan City (CN); Xuanyu SHI, Wuhan City (CN); Kui HUANG, Nanning City (CN); Zhenyu MU, Wuhan City (CN); Jie DING, Wuhan City (CN); Jiajun GUO, Wuhan City (CN); Jiaqiu HU, Nanning City (CN); Yiming QIN, Nanning City (CN); Houjian ZHAN, Nanning City (CN); Jian TANG, Nanning City (CN); Yixin ZHUO, Nanning City (CN); Huanxing QI, Nanning City (CN)

(21) Appl. No.: 18/521,269

(22) Filed: Nov. 28, 2023

(30) Foreign Application Priority Data
Apr. 26, 2023 (CN) 202310468283.1

(51) Int. Cl. H02J 13/00; H02J 3/00

(52) U.S. Cl. CPC H02J 13/00002; H02J 3/003

(57) ABSTRACT

A method and device for determining a daily peak load regulation capacity of a hydropower station are provided. The method includes: defining a concept of the daily peak load regulation capacity and setting two schemes, namely, finding an amplitude according to time and finding time according to an amplitude; distinguishing constraint conditions for the hydropower station in different periods; according to actual operation of the hydropower station, setting a daily average inflow and a daily initial water level, and determining a typical daily load process of peak load regulation of the hydropower station by analyzing an actual daily load of a power grid in a period; setting a peak load duration or a peak load regulation amplitude during typical load operation of the hydropower station; iteratively calculating a maximum peak load regulation amplitude or a maximum duration under this boundary condition to obtain the daily peak load regulation capacity.

### CROSS-REFERENCE TO RELATED APPLICATION

This patent application claims the benefit and priority of Chinese Patent Application No. 202310468283.1 filed with the China National Intellectual Property Administration on Apr. 26, 2023, the disclosure of which is incorporated by reference herein in its entirety as part of the present application.

### TECHNICAL FIELD

An embodiment of the present disclosure relates to the technical field of reservoir dispatching and economic operation of a hydropower station, in particular to a method and device for determining a daily peak load regulation capacity of a hydropower station.

### BACKGROUND

A hydropower station has become a first choice of power supply for peak load regulation because of its inherent characteristics such as fast start-stop and flexible operation of units. The peak load regulation operation of the hydropower station with adjustable performance enables other types of units to operate smoothly, save start-stop costs and system operation costs, and is of great significance to ensure the supply of electricity in a power grid and the safe and stable operation of the power grid.

In recent years, coordinated dispatching of water, wind and light has developed rapidly and is one of the important forms to realize the efficient utilization of clean energy. The randomness and intermittence of wind and light resources lead to the fluctuation and intermittence of wind power generation and photovoltaic power generation, while hydropower has the characteristics of flexible operation and strong peak load regulation capacity. The power generation system with complementary wind, light and water can solve the problem of renewable energy accommodation. The amount of new energy accommodated by the power grid through hydropower is closely related to the peak load regulation capacity of the hydropower station, and thus determining the peak load regulation capacity of hydropower under different conditions is an important premise to carry out the research on joint dispatching of water, wind and light. Therefore, it is a problem to be solved urgently in the industry to develop a method and device for determining a daily peak load regulation capacity of a hydropower station which can effectively overcome the defects in the above related technologies.

### SUMMARY

In view of the above problems existing in the prior art, an embodiment of the present disclosure provides a method and device for determining a daily peak load regulation capacity of a hydropower station.

In a first aspect, an embodiment of the present disclosure provides a method for determining a daily peak load regulation capacity of a hydropower station, including: Step 1, determining constraint conditions of the hydropower station in different periods, and determining a constraint condition of a typical calculation day; Step 2, performing a comprehensive analysis according to an actual load of a power grid in that day in a historical period to determine a typical daily load process of peak load regulation of the hydropower station in that day, that is, a peak load regulation operation mode of the hydropower station, and providing the typical daily load process of the hydropower station; Step 3, setting a daily average inflow Q̅ᵢₙ of a reservoir; Step 4, setting a peak load duration T in the typical daily load process of the hydropower station; Step 5, according to an actual operation situation of the hydropower station, determining that a daily peak load regulation amplitude N_{tf} has a range varying from 0 to an upper limit value N_{y} of the daily peak load regulation amplitude, and starting trial calculation from the daily peak load regulation amplitude N_{tf}=N_{y}; Step 6, according to a daily initial water level Z′, the daily average inflow Q̅ᵢₙ and a daily peak load output P_{f}=Pⱼ+N_{tf}, where Pⱼ is a forced output of the hydropower station, determining a specific daily load process of the hydropower station according to the set typical daily load process, determining, for each period, an outflow at the period and a final water level at the period by a trial calculation method according to an N˜H˜Q curve and a tail water level flow relationship curve of the hydropower station, and obtaining a hydropower station power generation flow process, a reservoir water level change process and a hydropower station output change process, if the power generation flow process and the reservoir water level change process corresponding to N_{tf} meet relevant constraint conditions in Step 1, recording that N_{tf} is feasible and proceeding to a next step; Step 7, if N_{tf} meets an accuracy requirement of a dichotomy in Step 5, recording a maximum peak load regulation amplitude when the peak load duration is T under a current boundary condition, as a maximum peak load regulation capacity; otherwise, changing a value of the daily peak load regulation amplitude N_{tf} according to the dichotomy, and returning to Step 6.

Based on the contents of the above method embodiment, according to the method for determining the daily peak load regulation capacity of the hydropower station provided in the embodiment of the present disclosure, constraint conditions of the hydropower station in different periods are determined, including: constraints on an installed capacity, operation characteristics and a maintenance plan of the hydropower station; comprehensive utilization requirements for flood control, sand retention and improvement of navigation conditions in a reservoir area and a river section under a dam; and reservoir dispatching requirements.

Based on the contents of the above method embodiment, according to the method for determining the daily peak load regulation capacity of the hydropower station provided in the embodiment of the present disclosure, the typical daily load process of the hydropower station is provided, including: a first load process, where t₁ is determined according to an actual situation and remains unchanged, and P_{f} is a peak load; a second load process, where t₁ is determined according to the actual situation and remains unchanged, Pⱼ is a forced output of the hydropower station, and P_{f} is the peak load; a third load process, where Pⱼ is the forced output of the hydropower station, P_{f} is the peak load, P_{y} is a shoulder load and P_{y}=(Pⱼ+P_{f})/2, t₁ is determined according to the actual situation and remains unchanged, and durations of the peak load and the shoulder load have a relationship of: t₂-t₁=t₃-t₂=t₄-t₃; a fourth load process, where Pⱼ is the forced output of the hydropower station, P_{f1} and P_{f2} are two peak loads in a day and have a relationship of P_{f1}=2P_{f2}, t₁ and t₃ are determined according to the actual situation and remain unchanged, and durations of the two peak loads have a relationship of t₂-t₁=t₄-t₃.

Based on the contents of the above method embodiment, according to the method for determining the daily peak load regulation capacity of the hydropower station provided in the embodiment of the present disclosure, the Step 4 is changed to: setting a peak load regulation amplitude N in the typical daily load process of the hydropower station, at this time, the peak load P_{f} is determined by P_{f}=Pⱼ+N.

Based on the contents of the above method embodiment, according to the method for determining the daily peak load regulation capacity of the hydropower station provided in the embodiment of the present disclosure, the Step 5 is changed to: determining a range from 0 to Δt of the peak load duration t according to the actual operation situation of the hydropower station, and performing trial calculation through the dichotomy from an upper limit Δt of the range; where the peak load durations t of the first and second load processes are t₂-t₁, the peak load duration t of the third load process is t₃-t₂, and the peak load duration t of the fourth load process is t₄-t₃.

Based on the contents of the above method embodiment, according to the method for determining the daily peak load regulation capacity of the hydropower station provided in the embodiment of the present disclosure, the Step 6 is changed to: according to the daily initial water level Z′, the daily average inflow Q̅ᵢₙ and the peak load duration t, determining the specific daily load process of the hydropower station according to the set typical daily load process; determining, for each period, the outflow at the period and the final water level at the period by the trial calculation method according to the N˜H˜Q curve and the tail water level flow relationship curve of the hydropower station, and obtaining the hydropower station power generation flow process, the reservoir water level change process and the hydropower station output change process; if the power generation flow process and the reservoir water level change process corresponding to t meet relevant constraint conditions in Step 1, recording that t is feasible and proceeding to the next step.

Based on the contents of the above method embodiment, according to the method for determining the daily peak load regulation capacity of the hydropower station provided in the embodiment of the present disclosure, the Step 7 is changed to: if t meets the accuracy requirement of the dichotomy in changed Step 5, recording that t is a maximum duration when the peak load regulation amplitude is N under the current boundary condition, as the maximum peak load regulation capacity; otherwise, changing a value of a peak load regulation duration t according to the dichotomy, and returning to changed Step 6.

In a second aspect, an embodiment of the present disclosure provides a device for determining a daily peak load regulation capacity of a hydropower station, including: a first main module, configured to determine constraint conditions of the hydropower station in different periods, and determine a constraint condition of a typical calculation day; a second main module, configured to perform a comprehensive analysis according to an actual load of a power grid in that day in a historical period to determine a typical daily load process of peak load regulation of the hydropower station in that day, that is, a peak load regulation operation mode of the hydropower station, and provide the typical daily load process of the hydropower station; a third main module, configured to set a daily average inflow Q̅ᵢₙ of a reservoir; a fourth main module, configured to set a peak load duration T in the typical daily load process of the hydropower station; a fifth main module, configured to, according to an actual operation situation of the hydropower station, determine that a daily peak load regulation amplitude N_{tf} has a range varying from 0 to an upper limit value N_{y} of the daily peak load regulation amplitude, and start trial calculation from the daily peak load regulation amplitude N_{tf}=N_{y}; a sixth main module, configured to, according to a daily initial water level Z′, the daily average inflow Q̅ᵢₙ and a daily peak load output P_{f}=Pⱼ+N_{tf}, where Pⱼ is a forced output of the hydropower station, determine a specific daily load process of the hydropower station according to the set typical daily load process, determine, for each period, an outflow at the period and a final water level at the period by a trial calculation method according to an N˜H˜Q curve and a tail water level flow relationship curve of the hydropower station, and obtain a hydropower station power generation flow process, a reservoir water level change process and a hydropower station output change process, if the power generation flow process and the reservoir water level change process corresponding to N_{tf} meet relevant constraint conditions in the first main module, record that N_{tf} is feasible and proceed to a next step; a seventh main module, configured to, if N_{tf} meets an accuracy requirement of a dichotomy in the fifth main module, record a maximum peak load regulation amplitude when the peak load duration is T under a current boundary condition, as a maximum peak load regulation capacity; otherwise, change a value of the daily peak load regulation amplitude N_{tf} according to the dichotomy, and return to the sixth main module.

In a third aspect, an embodiment of the present disclosure provides an electronic device, including:

at least one processor; and

at least one memory communicatively connected to the processor, where:

the memory stores program instructions executable by the processor, and the processor calls the program instructions to execute the method for determining the daily peak load regulation capacity of the hydropower station provided by any one of various implementations of the first aspect.

In a fourth aspect, an embodiment of the present disclosure provides a non-transient computer-readable storage medium, where the non-transient computer-readable storage medium stores computer instructions, and the computer instructions cause a computer to execute the method for determining the daily peak load regulation capacity of the hydropower station provided by any one of the various implementations of the first aspect.

According to the method and device for determining the daily peak load regulation capacity of the hydropower station provided by the embodiment of the present disclosure, the daily average inflow and the daily initial water level of the reservoir can be given according to the actual situation, so that the method has strong flexibility. The maximum peak load regulation amplitude is determined by the dichotomy, and its accuracy is controllable. A basis is provided for the later optimal dispatching scheme; after setting constraint conditions, the present disclosure is closer to an actual operation of the hydropower station, which can better reflect daily regulation performance of a hydropower station reservoir and reflect operation characteristics of the reservoir.

### BRIEF DESCRIPTION OF THE DRAWINGS

In order to more clearly explain the embodiments of the present disclosure or the technical scheme in the prior art, the drawings needed in the description of the embodiments or the prior art will be briefly introduced hereinafter. Obviously, the drawings in the following description are some embodiments of the present disclosure, and other drawings can be obtained according to these drawings without creative work for those skilled in the art.

FIG. 1 is a schematic flow diagram of a method for determining a daily peak load regulation capacity of a hydropower station according to an embodiment of the present disclosure.

FIG. 2 is a schematic structural diagram of a device for determining a daily peak load regulation capacity of a hydropower station according to an embodiment of the present disclosure.

FIG. 3 is a schematic diagram of a physical structure of an electronic device according to an embodiment of the present disclosure.

FIG. 4 is a schematic diagram of four basic typical daily load processes according to an embodiment of the present disclosure.

### DETAILED DESCRIPTION OF THE EMBODIMENTS

In order to make the purpose, technical scheme and advantages of the embodiment of the present disclosure more clear, the technical scheme in the embodiment of the present disclosure will be described clearly and completely below with the attached drawings in the embodiment of the present disclosure. Obviously, the described embodiments are some embodiments of the present disclosure, rather than all of the embodiments. Based on the embodiments in the present disclosure, all other embodiments obtained by those skilled in the art without creative work belong to the scope of protection of the present disclosure. In addition, the technical features of each embodiment or a single embodiment provided by the present disclosure can be arbitrarily combined with each other to form a feasible technical scheme, which is not limited by the sequence of steps and/or the structural composition mode, but must be based on the content that those skilled in the art can implement. When the combination of technical schemes is contradictory or impossible, it should be considered that the combination of such technical schemes does not exist and is not within the scope of protection claimed by the present disclosure.

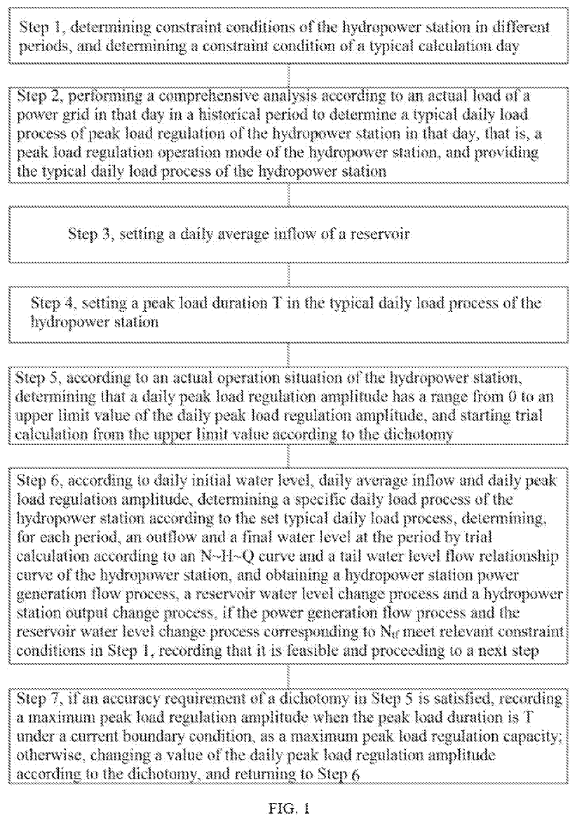

The embodiment of the present disclosure provides a method for determining a daily peak load regulation capacity of a hydropower station. Referring to FIG. 1, the method includes Step 1 to Step 7. In Step 1, constraint conditions of the hydropower station in different periods are determined, and a constraint condition of a typical calculation day is determined. In Step 2, a comprehensive analysis is performed according to an actual load of a power grid in that day in a historical period to determine a typical daily load process of peak load regulation of the hydropower station in that day, that is, a peak load regulation operation mode of the hydropower station, and the typical daily load process of the hydropower station is provided. In Step 3, a daily average inflow Q̅ᵢₙ of a reservoir is set. In Step 4, a peak load duration T in the typical daily load process of the hydropower station is set. In Step 5, according to an actual operation situation of the hydropower station, it is determined that a daily peak load regulation amplitude N_{tf} has a range varying from 0 to an upper limit value N_{y} of the daily peak load regulation amplitude, and trial calculation is started from the daily peak load regulation amplitude N_{tf}=N_{y}. In Step 6, according to a daily initial water level Z′, the daily average inflow Q and a daily peak load output P_{f}=Pⱼ+N_{tf}, where Pⱼ is a forced output of the hydropower station, a specific daily load process of the hydropower station is determined according to the set typical daily load process, and for each period, an outflow at the period and a final water level at the period are determined by a trial calculation method according to an N˜H˜Q curve and a tail water level flow relationship curve of the hydropower station. Finally, a hydropower station power generation flow process, a reservoir water level change process and a hydropower station output change process are obtained, and if the power generation flow process and the reservoir water level change process corresponding to N_{tf} meet relevant constraint conditions in Step 1, it is recording that N_{tf} is feasible and the method proceeds to a next step. In Step 7, if N_{tf} meets an accuracy requirement of a dichotomy in Step 5, a maximum peak load regulation amplitude when the peak load duration is T under a current boundary condition is recorded as a maximum peak load regulation capacity; otherwise, the value of the daily peak load regulation amplitude N_{tf} is changed according to the dichotomy, and the method returns to Step 6.

Based on the content of the above method embodiment, as an optional embodiment, according to the method for determining the daily peak load regulation capacity of the hydropower station provided in the embodiment of the present disclosure, constraint conditions of the hydropower station in different periods are determined, including: constraints on an installed capacity, operation characteristics and a maintenance plan of the hydropower station; comprehensive utilization requirements for flood control, sand retention and improvement of navigation conditions in a reservoir area and a river section under a dam; and reservoir dispatching requirements.

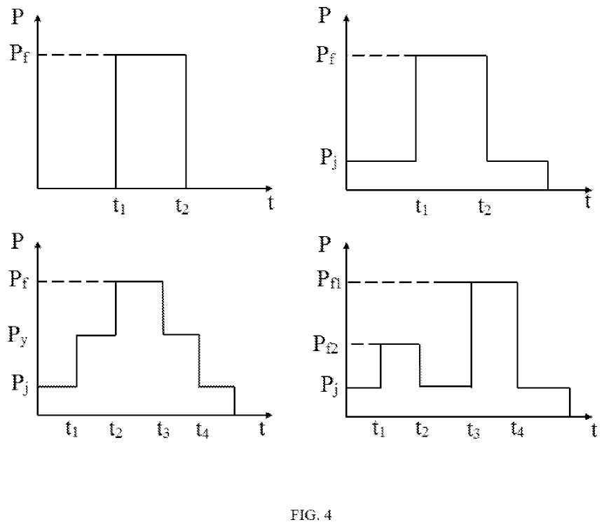

Referring to FIG. 4, based on the content of the above method embodiment, as an optional embodiment, according to the method for determining the daily peak load regulation capacity of the hydropower station provided in the embodiment of the present disclosure, the typical daily load process of the hydropower station is provided, including: a first load process (an upper left sub-diagram in FIG. 4), where t₁ is determined according to the actual situation and remains unchanged, and P_{f} is a peak load; a second load process (an upper right sub-diagram in FIG. 4), where t₁ is determined according to the actual situation and remains unchanged, Pⱼ is a forced output of the hydropower station, and P_{f} is a peak load; a third load process (a lower left sub-diagram in FIG. 4), where Pⱼ is a forced output of the hydropower station, P_{f} is a peak load, P_{y} is a shoulder load, and P_{y}=(Pⱼ+P_{f})/2, t₁ is determined according to the actual situation and remains unchanged, and durations of the peak load and the shoulder load have a relationship of: t₂-t₁=t₃-t₂=t₄-t₃; a fourth load process (a lower right sub-diagram in FIG. 4), where Pⱼ is a forced output of the hydropower station, P_{f1} and P_{f2} are two peak loads in a day and have a relationship of P_{f1}=2P_{f2}, t₁ and t₃ are determined according to the actual situation and remain unchanged, and the durations of the two peak loads have the relationship of t₂-t₁=t₄-t₃.

Based on the content of the above method embodiment, as an optional embodiment, according to the method for determining the daily peak load regulation capacity of the hydropower station provided in the embodiment of the present disclosure, the Step 4 is changed to: setting the peak load regulation amplitude N in a typical daily load process of the hydropower station, at this time, the peak load P_{f} is determined by P_{f}=Pⱼ+N.

Based on the content of the above method embodiment, as an optional embodiment, according to the method for determining the daily peak load regulation capacity of the hydropower station provided in the embodiment of the present disclosure, the Step 5 is changed to: determining a range from 0 to Δt of the peak load duration t according to an actual operation situation of the hydropower station, and performing trial calculation through a dichotomy from an upper limit Δt of the range; where the peak load durations t of the first and second load processes are t₂-t₁, the peak load duration t of the third load process is t₃-t₂, and the peak load duration t of the fourth load process is t₄-t₃.

Based on the content of the above method embodiment, as an optional embodiment, according to the method for determining the daily peak load regulation capacity of the hydropower station provided in the embodiment of the present disclosure, the Step 6 is changed to: according to the daily initial water level Z′, the daily average inflow Q̅ᵢₙ and the peak load duration t, determining a specific daily load process of the hydropower station according to the set typical daily load process; determining, for each period, an outflow at the period and a final water level at the period by a trial calculation method according to an N˜H˜Q curve and a tail water level flow relationship curve of the hydropower station, and obtaining a hydropower station power generation flow process, a reservoir water level change process and a hydropower station output change process; if the power generation flow process and the reservoir water level change process corresponding to t meet relevant constraint conditions in Step 1, recording that t is feasible and proceeding to a next step.

Based on the content of the above method embodiment, as an optional embodiment, according to the method for determining the daily peak load regulation capacity of the hydropower station provided in the embodiment of the present disclosure, the Step 7 is changed to: if t meets an accuracy requirement of a dichotomy in changed Step 5, recording that t is a maximum duration when the peak load regulation amplitude is N under current boundary conditions, as a maximum peak load regulation capacity; otherwise, changing the value of the daily peak load regulation duration t according to the dichotomy, and returning to changed Step 6.

According to the method for determining the daily peak load regulation capacity of the hydropower station provided by the embodiment of the present disclosure, the daily average inflow and the daily initial water level of the reservoir can be given according to the actual situation, so that the method has strong flexibility. The maximum peak load regulation amplitude is determined by the dichotomy, and its accuracy is controllable. A basis is provided for the later optimal dispatching scheme; after setting constraint conditions, the present disclosure is closer to an actual operation of the hydropower station, which can better reflect daily regulation performance of a hydropower station reservoir and reflect operation characteristics of the reservoir.

Specifically, determining constraint conditions of the hydropower station in different periods (a low water period, a flood period and a water storage period, etc.) includes: defining limits on an installed capacity, operation characteristics and a maintenance plan of the hydropower station in the low water period, the flood period and the water storage period; comprehensive utilization requirements for flood control, sand retention and improvement of navigation conditions in a reservoir area and a river section under a dam; and reservoir dispatching requirements. After determining the period to be calculated, the limit range of a total output Nₕ being Nₘᵢₙ≤Nₕ≤Nₘₐₓ, the limit range of a water level Z being Zₘᵢₙ≤Z≤Zₘₐₓ, the amplitude variation constraint of the water level Z, and the limit range of the outflow Qₒᵤₜ being Qₘᵢₙ≤Qₒᵤₜ≤Qₘₐₓ are obtained.

The setting of the boundary conditions includes: according to the actual load of the power grid, the actual operation situation of the hydropower station and the incoming water situation in the period calculated by the method, and combining with the constraint condition in the Step 1, setting the values of the daily average inflow Q̅ᵢₙ, the daily initial water level Z′ and the typical daily load process Ω of the hydropower station. Further, the range 0≤N_{tf}≤N_{y} of the peak load regulation capacity of the hydropower station is calculated.

Determining the value of the invariant index includes: setting the peak load start time t₁ (if it is the fourth load process, t₁ and t₃ need to be set) and the duration T in the typical daily load process of the hydropower station.

Iterative calculation includes: Step 1: according to the given typical daily load process Ω, the daily average inflow Q̅ᵢₙ of the reservoir, and the daily initial water level Z′, the daily water consumption for power generation can be determined; Step 2: according to the daily peak load regulation capacity of the hydropower station N_{tf} (∈[0, N_{y}], where N_{y} is a theoretical maximum) (N_{tf}=N_{y} in a first cycle, and note a left boundary as N₁=0 and a right boundary as N₂=N_{tf}) and the daily water consumption, preliminarily estimating the daily power generation of the hydropower station E′_{day}, and recording a midpoint N_{zj}=(N₁+N₂)/2; Step 3: determining the daily load process according to N_{tf} and the daily peak load regulation operation mode Ω given by Step 1; determining, for each period, an outflow at the period and a final water level at the period by a trial calculation method according to an N˜H˜Q curve and a tail water level flow relationship curve of the hydropower station, and obtaining a hydropower station power generation flow process and a reservoir water level change process; Step 4: if the reservoir water level process meets the upper and lower limits of the water level and the amplitude variation constraints, and the outflow for each period meets the outflow constraints, proceeding to Step 6; otherwise, proceeding to the next step; Step 5: if the reservoir water level in any period exceeds the lower limit, N_{tf}=(N₁+N_{zj})/2 and N₂=N_{zj}; if the reservoir water level exceeds the upper limit, N_{tf}=(N₂+N_{zj})/2 and N₁=N_{zj}, and skipping to Step 2; otherwise, proceeding to the next step; Step 6: if N_{tf} meets the accuracy requirement of the dichotomy, proceeding to the next step; otherwise, N_{tf}=(N₂+N_{zj})/2 and N₁=N_{zj}, and skipping to Step 2; Step 7: recording that N_{tf} is a maximum peak load regulation amplitude of the hydropower station when the peak load duration is T under current Ω, Q̅ᵢₙ and Z′.

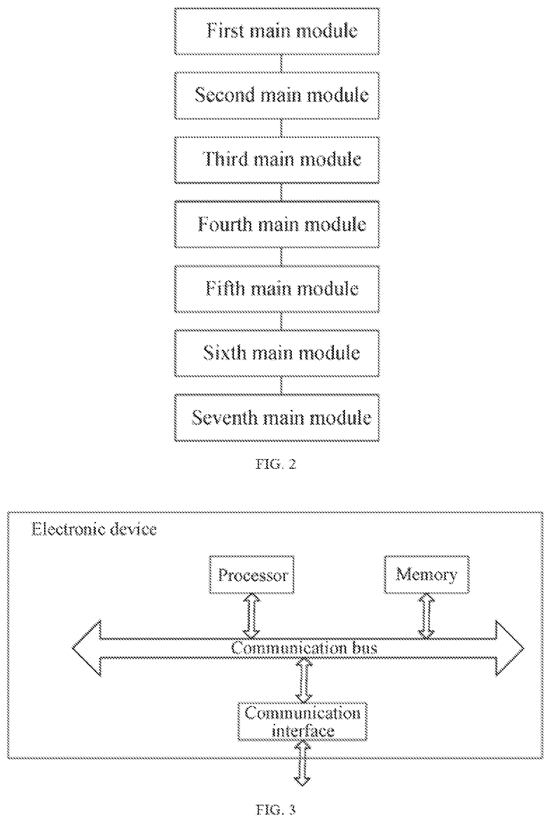

The implementation basis of each embodiment of the present disclosure is realized through programmed processing by a device with a processor function. Therefore, in engineering practice, the technical schemes of various embodiments of the present disclosure and the functions thereof can be packaged into various modules. Based on this reality, on the basis of the above embodiments, an embodiment of the present disclosure provides a device for determining a daily peak load regulation capacity of a hydropower station, which is used for executing the method for determining the daily peak load regulation capacity of the hydropower station in the above method embodiment. Referring to FIG. 2, the device includes: a first main module, configured to determine constraint conditions of the hydropower station in different periods, and determine a constraint condition of a typical calculation day; a second main module, configured to perform a comprehensive analysis according to an actual load of a power grid in that day in a historical period to determine a typical daily load process of peak load regulation of the hydropower station in that day, that is, a peak load regulation operation mode of the hydropower station, and provide the typical daily load process of the hydropower station; a third main module, configured to set a daily average inflow Q̅ᵢₙ of a reservoir; a fourth main module, configured to set a peak load duration T in the typical daily load process of the hydropower station; a fifth main module, configured to, according to an actual operation situation of the hydropower station, determine that a daily peak load regulation amplitude N_{tf} has a range varying from 0 to an upper limit value N_{y} of the daily peak load regulation amplitude, and start trial calculation from the daily peak load regulation amplitude N_{tf}=N_{y}; a sixth main module, configured to, according to a daily initial water level Z′, a daily average inflow Q̅ᵢₙ and a daily peak load output P_{f}=Pⱼ+N_{tf}, where Pⱼ is a forced output of the hydropower station, determine a specific daily load process of the hydropower station according to the set typical daily load process, determine, for each period, an outflow at the period and a final water level at the period by a trial calculation method according to an N˜H˜Q curve and a tail water level flow relationship curve of the hydropower station, and obtain a hydropower station power generation flow process, a reservoir water level change process and a hydropower station output change process, if the power generation flow process and the reservoir water level change process corresponding to N_{tf} meet relevant constraint conditions in the first main module, record that N_{tf} is feasible and proceed to a next step; a seventh main module, configured to, if N_{tf} meets an accuracy requirement of a dichotomy in the fifth main module, record a maximum peak load regulation amplitude when the peak load duration is T under a current boundary condition, as a maximum peak load regulation capacity; otherwise, change the value of the daily peak load regulation amplitude N_{tf} according to the dichotomy, and return to the sixth main module.

The device for determining the daily peak load regulation capacity of the hydropower station provided by the embodiment of the present disclosure uses several modules shown in FIG. 2. The daily average inflow and the daily initial water level of the reservoir can be given according to the actual situation, so that the device has strong flexibility. The maximum peak load regulation amplitude is determined by the dichotomy, and its accuracy is controllable. A basis is provided for the later optimal dispatching scheme; after setting constraint conditions, the device is closer to an actual operation of the hydropower station, which can better reflect daily regulation performance of a hydropower station reservoir and reflect operation characteristics of the reservoir.

It should be noted that in addition to implementing the method in the above method embodiment, the device in the device embodiment provided by the present disclosure can be used to implement the method in other method embodiments provided by the present disclosure. The difference is that the corresponding functional modules are arranged, and the principle is basically the same as that in the above device embodiment provided by the present disclosure, so long as those skilled in the art refer to the specific technical schemes in other method embodiments on the basis of the above device embodiment. By combining the technical features, the corresponding technical means and the technical schemes consisted of these technical means can be obtained. On the premise of ensuring the practicability of the technical scheme, the device in the above device embodiments can be improved, so as to obtain corresponding device-like embodiments, which can be used to implement the method in other method-like embodiments. For example:

Based on the content of the above device embodiment, as an optional embodiment, the device for determining the daily peak load regulation capacity of the hydropower station provided in the embodiment of the present disclosure further includes a first sub-module, which is configured to determine constraint conditions of the hydropower station in different periods, including: constraints on an installed capacity, operation characteristics and a maintenance plan of the hydropower station; comprehensive utilization requirements for flood control, sand retention and improvement of navigation conditions in a reservoir area and a river section under a dam; and reservoir dispatching requirements.

Based on the content of the above device embodiment, as an optional embodiment, the device for determining the daily peak load regulation capacity of the hydropower station provided in the embodiment of the present disclosure further includes a second sub-module, which is configured to provide the typical daily load process of the hydropower station, including: a first load process, where t₁ is determined according to the actual situation and remains unchanged, and P_{f} is a peak load; a second load process, where t₁ is determined according to the actual situation and remains unchanged, Pⱼ is a forced output of the hydropower station, and P_{f} is a peak load; a third load process, where Pⱼ is a forced output of the hydropower station, P_{f} is a peak load, P_{y} is a shoulder load and P_{y}=(Pⱼ+P_{f})/2, t₁ is determined according to the actual situation and remains unchanged, and durations of the peak load and the shoulder load have a relationship of: t₂-t₁=t₃-t₂=t₄-t₃; a fourth load process, where Pⱼ is a forced output of the hydropower station, P_{f1} and P_{f2} are two peak loads in a day and have a relationship of P_{f1}=2P_{f2}, t₁ and t₃ are determined according to the actual situation and remains unchanged, and the durations of the two peak loads have the relationship of t₂-t₁=t₄-t₃.

Based on the content of the above device embodiment, as an optional embodiment, the device for determining the daily peak load regulation capacity of the hydropower station provided in the embodiment of the present disclosure further includes a third sub-module, which is configured to change Step 4 to: setting the peak load regulation amplitude N in a typical daily load process of the hydropower station, at this time, the peak load P_{f} is determined by P_{f}=Pⱼ+N.

Based on the content of the above device embodiment, as an optional embodiment, the device for determining the daily peak load regulation capacity of the hydropower station provided in the embodiment of the present disclosure further includes a fourth sub-module, which is configured to change Step 5 to: determining a range from 0 to Δt of the peak load duration t according to an actual operation situation of the hydropower station, and performing trial calculation by a dichotomy from an upper limit Δt of the range; where the peak load durations t of the first and second load processes are t₂-t₁, the peak load duration t of the third load process is t₃-t₂, and the peak load duration t of the fourth load process is t₄-t₃.

Based on the content of the above device embodiment, as an optional embodiment, the device for determining the daily peak load regulation capacity of the hydropower station provided in the embodiment of the present disclosure further includes a fifth sub-module, which is configured to change Step 6 to: according to the daily initial water level Z′, the daily average inflow Q̅ᵢₙ and the peak load duration t, determining a specific daily load process of the hydropower station according to the set typical daily load process; determining, for each period, an outflow at the period and a final water level at the period by a trial calculation method according to an N˜H˜Q curve and a tail water level flow relationship curve of the hydropower station, and obtaining a hydropower station power generation flow process, a reservoir water level change process and a hydropower station output change process; if the power generation flow process and the reservoir water level change process corresponding to t meet relevant constraint conditions in Step 1, recording that t is feasible and proceeding to a next step.

Based on the content of the above device embodiment, as an optional embodiment, the device for determining the daily peak load regulation capacity of the hydropower station provided in the embodiment of the present disclosure further includes a sixth sub-module, which is configured to change Step 7 to: if t meets an accuracy requirement of a dichotomy in changed Step 5, recording that t is a maximum duration when the peak load regulation amplitude is N under current boundary conditions, as a maximum peak load regulation capacity; otherwise, changing the value of the daily peak load regulation duration t according to the dichotomy, and returning to changed Step 6.

The method of the embodiment of the present disclosure is implemented based on an electronic device. Therefore, it is necessary to introduce the related electronic device. For this purpose, an embodiment of the present disclosure provides an electronic device. As shown in FIG. 3, the electronic device includes at least one processor, a communication interface, at least one memory and a communication bus, where the at least one processor, the communication interface and the at least one memory communicate with each other through the communication bus. The at least one processor can call logic instructions in the at least one memory to execute all or part of the steps of the method provided by each of the above method embodiments.

In addition, the logic instructions in the above at least one memory can be implemented in the form of software functional units and can be stored in a computer-readable storage medium when being sold or used as an independent product. Based on this understanding, the technical scheme of the present disclosure can be embodied in the form of a software product essentially or for the part that contributes to the prior art or the part of the technical scheme. The computer software product is stored in a storage medium and includes several instructions so that a computer device (which can be a personal computer, a server, a network device, etc.) executes all or part of the steps of the method described in various method embodiments of the present disclosure. The above storage media include: a U disk, a mobile hard disk, a Read-Only Memory (ROM), a Random Access Memory (RAM), a magnetic disk or an optical disk and other media that can store program codes.

The device embodiments described above are only schematic, in which the units described as separate components may or may not be physically separated, and the components displayed as units may or may not be physical units, that is, they may be located in one place or distributed to a plurality of network units. Some or all of the modules can be selected according to actual needs to achieve the purpose of this embodiment. Those skilled in the art can understand and implement the purpose without creative work.

From the description of the above embodiments, those skilled in the art can clearly understand that each embodiment can be implemented by means of software plus a necessary general hardware platform, and of course it can also be implemented by hardware. Based on this understanding, the above technical scheme can be embodied in the form of a software product essentially or for the part that contributes to the prior art. The computer software product can be stored in a computer-readable storage medium, such as an ROM/RAM, a magnetic disk, an optical disk, etc., and includes several instructions so that a computer device (which can be a personal computer, a server, or a network device, etc.) executes the methods described in various embodiments or some parts of the embodiments.

The flowcharts and block diagrams in the drawings show the architecture, functions and operations of possible implementations of systems, methods and computer program products according to various embodiments of the present disclosure. Based on this understanding, each block in a flowchart or block diagram can represent a part of a module, a program segment or a code. The part of the module, the program segment or the code contains one or more executable instructions for implementing specified logical functions. It should also be noted that in some alternative implementations, the functions noted in the blocks may occur in a different order than those noted in the drawings. For example, two consecutive blocks may actually be executed substantially in parallel, or sometimes in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or actions, or can be implemented by a combination of dedicated hardware and computer instructions.

It should be noted that the terms “including”, “containing” or any other variation thereof are intended to cover non-exclusive inclusion, so that a process, method, article or device including a series of elements includes not only those elements, but also other elements not explicitly listed, or elements inherent to such process, method, article or device. Without more restrictions, the element defined by the phrase “including . . . ” does not exclude the existence of other identical elements in the process, method, article or device including the elements.

Finally, it should be explained that the above embodiments are only used to illustrate the technical scheme of the present disclosure, rather than to limit the technical scheme. Although the present disclosure has been described in detail with reference to the foregoing embodiments, those skilled in the art should understand that it is still possible to modify the technical scheme described in the foregoing embodiments, or to substitute some technical features equivalently. However, these modifications or substitutions do not make the essence of the corresponding technical schemes deviate from the spirit and scope of the technical schemes of various embodiments of the present disclosure.

What is claimed is:

1. A method for determining a daily peak load regulation capacity of a hydropower station, comprising:
Step 1, determining constraint conditions of the hydropower station in different periods, and determining a constraint condition of a typical calculation day;
Step 2, performing a comprehensive analysis according to an actual load of a power grid in that day in a historical period to determine a typical daily load process of peak load regulation of the hydropower station in that day, that is, a peak load regulation operation mode of the hydropower station, and providing the typical daily load process of the hydropower station;
Step 3, setting a daily average inflow Q̅ᵢₙ of a reservoir;
Step 4, setting a peak load duration T in the typical daily load process of the hydropower station;
Step 5, according to an actual operation situation of the hydropower station, determining that a daily peak load regulation amplitude N_{tf} has a range varying from 0 to an upper limit value N_{y} of the daily peak load regulation amplitude, and starting trial calculation from the daily peak load regulation amplitude N_{tf}=N_{y};
Step 6, according to a daily initial water level Z′, the daily average inflow Q̅ᵢₙ and a daily peak load output P_{f}=Pⱼ+N_{tf}, where Pⱼ is a forced output of the hydropower station, determining a specific daily load process of the hydropower station according to the set typical daily load process, determining, for each period, an outflow at the period and a final water level at the period by a trial calculation method according to an N˜H˜Q curve and a tail water level flow relationship curve of the hydropower station, and obtaining a hydropower station power generation flow process, a reservoir water level change process and a hydropower station output change process, if the power generation flow process and the reservoir water level change process corresponding to N_{tf} meet relevant constraint conditions in Step 1, recording that N_{tf} is feasible and proceeding to a next step;
Step 7, if N_{tf} meets an accuracy requirement of a dichotomy in Step 5, recording a maximum peak load regulation amplitude when the peak load duration is T under a current boundary condition, as a maximum peak load regulation capacity; otherwise, changing a value of the daily peak load regulation amplitude N_{tf} according to the dichotomy, and returning to Step 6.

2. The method according to claim 1, wherein the determining constraint conditions of the hydropower station in different periods comprises determining: constraints on an installed capacity, operation characteristics and a maintenance plan of the hydropower station;
comprehensive utilization requirements for flood control, sand retention and improvement of navigation conditions in a reservoir area and a river section under a dam; and reservoir dispatching requirements.

3. The method according to claim 2, wherein the providing the typical daily load process of the hydropower station comprises providing: a first load process, wherein t₁ is determined according to an actual situation and remains unchanged, and P_{f} is a peak load; a second load process, wherein t₁ is determined according to the actual situation and remains unchanged, Pⱼ is a forced output of the hydropower station, and P_{f} is the peak load; a third load process, wherein Pⱼ is the forced output of the hydropower station, P_{f} is the peak load, P_{y} is a shoulder load and P_{y}=(Pⱼ+P_{f})/2, t₁ is determined according to the actual situation and remains unchanged, and durations of the peak load and the shoulder load have a relationship of: t₂-t₁=t₃-t₂=t₄-t₃; and a fourth load process, wherein Pⱼ is the forced output of the hydropower station, P_{f1} and P_{f2} are two peak loads in a day and have a relationship of P_{f1}=2P_{f2}, t₁ and t₃ are determined according to the actual situation and remain unchanged, and durations of the two peak loads have a relationship of t₂-t₁=t₄-t₃.

4. The method according to claim 3, wherein the Step 4 is changed to: setting a peak load regulation amplitude N in the typical daily load process of the hydropower station, at this time, the peak load P_{f} is determined by P_{f}=Pⱼ+N.

5. The method according to claim 4, wherein the Step 5 is changed to: determining a range from 0 to Δt of the peak load duration t according to the actual operation situation of the hydropower station, and performing trial calculation through the dichotomy from an upper limit Δt of the range; wherein the peak load durations t of the first and second load processes are t₂-t₁, the peak load duration t of the third load process is t₃-t₂, and the peak load duration t of the fourth load process is t₄-t₃.

6. The method according to claim 5, wherein the Step 6 is changed to: according to the daily initial water level Z′, the daily average inflow Q̅ᵢₙ and the peak load duration t, determining the specific daily load process of the hydropower station according to the set typical daily load process; determining, for each period, the outflow at the period and the final water level at the period by the trial calculation method according to the N˜H˜Q curve and the tail water level flow relationship curve of the hydropower station, and obtaining the hydropower station power generation flow process, the reservoir water level change process and the hydropower station output change process; if the power generation flow process and the reservoir water level change process corresponding to t meet relevant constraint conditions in Step 1, recording that t is feasible and proceeding to the next step.

7. The method according to claim 6, wherein the Step 7 is changed to: if t meets the accuracy requirement of the dichotomy in changed Step 5, recording that t is a maximum duration when the peak load regulation amplitude is N under the current boundary condition, as the maximum peak load regulation capacity; otherwise, changing a value of a peak load regulation duration t according to the dichotomy, and returning to changed Step 6.

8. A device for determining a daily peak load regulation capacity of a hydropower station, comprising:
a first main module, configured to determine constraint conditions of the hydropower station in different periods, and determine a constraint condition of a typical calculation day;
a second main module, configured to perform a comprehensive analysis according to an actual load of a power grid in that day in a historical period to determine a typical daily load process of peak load regulation of the hydropower station in that day, that is, a peak load regulation operation mode of the hydropower station, and provide the typical daily load process of the hydropower station;
a third main module, configured to set a daily average inflow Q̅ᵢₙ of a reservoir;
a fourth main module, configured to set a peak load duration T in the typical daily load process of the hydropower station;
a fifth main module, configured to, according to an actual operation situation of the hydropower station, determine that a daily peak load regulation amplitude N_{tf} has a range varying from 0 to an upper limit value N_{y} of the daily peak load regulation amplitude, and start trial calculation from the daily peak load regulation amplitude N_{tf}=N_{y};
a sixth main module, configured to, according to a daily initial water level Z′, the daily average inflow Q̅ᵢₙ and a daily peak load output P_{f}=Pⱼ+N_{tf}, where Pⱼ is a forced output of the hydropower station, determine a specific daily load process of the hydropower station according to the set typical daily load process, determine, for each period, an outflow at the period and a final water level at the period by a trial calculation method according to an N˜H˜Q curve and a tail water level flow relationship curve of the hydropower station, and obtain a hydropower station power generation flow process, a reservoir water level change process and a hydropower station output change process, if the power generation flow process and the reservoir water level change process corresponding to N_{tf} meet relevant constraint conditions in the first main module, record that it is feasible and proceed to a next step;
a seventh main module, configured to, if N_{tf} meets an accuracy requirement of a dichotomy in the fifth main module, record a maximum peak load regulation amplitude when the peak load duration is T under a current boundary condition, as a maximum peak load regulation capacity; otherwise, change a value of the daily peak load regulation amplitude N_{tf} according to the dichotomy, and return to the sixth main module.

9. An electronic device, comprising:
at least one processor, at least one memory and a communication interface; wherein
the processor, the memory and the communication interface are in communication with each other; and
the memory stores program instructions executable by the processor, and the processor calls the program instructions to execute the method according to claim 1.

10. The electronic device according to claim 9, wherein the determining constraint conditions of the hydropower station in different periods comprises determining: constraints on an installed capacity, operation characteristics and a maintenance plan of the hydropower station; comprehensive utilization requirements for flood control, sand retention and improvement of navigation conditions in a reservoir area and a river section under a dam; and reservoir dispatching requirements.

11. The electronic device according to claim 10, wherein the providing the typical daily load process of the hydropower station comprises providing: a first load process, wherein t₁ is determined according to an actual situation and remains unchanged, and P_{f} is a peak load; a second load process, wherein t₁ is determined according to the actual situation and remains unchanged, Pⱼ is a forced output of the hydropower station, and P_{f} is the peak load; a third load process, wherein Pⱼ is the forced output of the hydropower station, P_{f} is the peak load, P_{y} is a shoulder load and P_{y}=(Pⱼ+P_{f})/2, t₁ is determined according to the actual situation and remains unchanged, and durations of the peak load and the shoulder load have a relationship of: t₂-t₁=t₃-t₂=t₄-t₃; and a fourth load process, wherein Pⱼ is the forced output of the hydropower station, P_{f1} and P_{f2} are two peak loads in a day and have a relationship of P_{f1}=2P_{f2}, t₁ and t₃ are determined according to the actual situation and remain unchanged, and durations of the two peak loads have a relationship of t₂-t₁=t₄-t₃.

12. The electronic device according to claim 11, wherein the Step 4 is changed to: setting a peak load regulation amplitude N in the typical daily load process of the hydropower station, at this time, the peak load P_{f} is determined by P_{f}=Pⱼ+N.

13. The electronic device according to claim 12, wherein the Step 5 is changed to: determining a range from 0 to Δt of the peak load duration t according to the actual operation situation of the hydropower station, and performing trial calculation through the dichotomy from an upper limit Δt of the range; wherein the peak load durations t of the first and second load processes are t₂-t₁, the peak load duration t of the third load process is t₃-t₂, and the peak load duration t of the fourth load process is t₄-t₃.

14. The electronic device according to claim 13, wherein the Step 6 is changed to: according to the daily initial water level Z′, the daily average inflow Q̅ᵢₙ and the peak load duration t, determining the specific daily load process of the hydropower station according to the set typical daily load process; determining, for each period, the outflow at the period and the final water level at the period by the trial calculation method according to the N˜H˜Q curve and the tail water level flow relationship curve of the hydropower station, and obtaining the hydropower station power generation flow process, the reservoir water level change process and the hydropower station output change process; if the power generation flow process and the reservoir water level change process corresponding to t meet relevant constraint conditions in Step 1, recording that t is feasible and proceeding to the next step.

15. The electronic device according to claim 14, wherein the Step 7 is changed to: if t meets the accuracy requirement of the dichotomy in changed Step 5, recording that t is a maximum duration when the peak load regulation amplitude is N under the current boundary condition, as the maximum peak load regulation capacity; otherwise, changing a value of a peak load regulation duration t according to the dichotomy, and returning to changed Step 6.

16. A non-transient computer-readable storage medium, wherein the non-transient computer-readable storage medium stores computer instructions, and the computer instructions cause a computer to execute the method according to claim 1.

17. The non-transient computer-readable storage medium according to claim 16, wherein the determining constraint conditions of the hydropower station in different periods comprises determining: constraints on an installed capacity, operation characteristics and a maintenance plan of the hydropower station; comprehensive utilization requirements for flood control, sand retention and improvement of navigation conditions in a reservoir area and a river section under a dam; and reservoir dispatching requirements.

18. The non-transient computer-readable storage medium according to claim 17, wherein the providing the typical daily load process of the hydropower station comprises providing: a first load process, wherein t₁ is determined according to an actual situation and remains unchanged, and P_{f} is a peak load; a second load process, wherein t₁ is determined according to the actual situation and remains unchanged, Pⱼ is a forced output of the hydropower station, and P_{f} is the peak load; a third load process, wherein Pⱼ is the forced output of the hydropower station, P_{f} is the peak load, P_{y} is a shoulder load and P_{y}=(Pⱼ+P_{f})/2, t₁ is determined according to the actual situation and remains unchanged, and durations of the peak load and the shoulder load have a relationship of: t₂-t₁=t₃-t₂=t₄-t₃; and a fourth load process, wherein Pⱼ is the forced output of the hydropower station, P_{f1} and P_{f2} are two peak loads in a day and have a relationship of P_{f1}=2P_{f2}, t₁ and t₃ are determined according to the actual situation and remain unchanged, and durations of the two peak loads have a relationship of t₂-t₁=t₄-t₃.

19. The non-transient computer-readable storage medium according to claim 18, wherein the Step 4 is changed to: setting a peak load regulation amplitude N in the typical daily load process of the hydropower station, at this time, the peak load P_{f} is determined by P_{f}=Pⱼ+N.

20. The non-transient computer-readable storage medium according to claim 19, wherein the Step 5 is changed to: determining a range from 0 to Δt of the peak load duration t according to the actual operation situation of the hydropower station, and performing trial calculation through the dichotomy from an upper limit Δt of the range; wherein the peak load durations t of the first and second load processes are t₂-t₁, the peak load duration t of the third load process is t₃-t₂, and the peak load duration t of the fourth load process is t₄-t₃.
